(19) United States
(12) Patent Application Publication
(10) Pub. No.: US 2009/0193474 A1
(43) Pub. Date: Jul. 30, 2009

(54) Method and Apparatus for Moving Viewing Sessions Among Different Devices in a Home Network

(75) Inventor: Robert C. Stein, Coopersburg, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 12/022,478

(22) Filed: Jan. 30, 2008

(51) Int. Cl. H04N 7/18; H04N 7/16

(52) U.S. Cl. 725/82; 725/141

(57) ABSTRACT

A method is provided for rendering digital content items with a second media renderer in a network having at least one control point, at least one media server, and a plurality of media renderers. The method includes presenting a list of one or more digital content items currently being rendered by any media renderer in communication with the network. A user input is received selecting a digital content item that is currently being rendered by a first media renderer. In response to the user input, the second media renderer is caused to request transmission of the selected digital content item from a first media server associated with the first media renderer to the second media renderer. The network is configured to allow digital content items stored in any media server in communication with the network to be located by any control point of the network and to be transferred for rendering by any media renderer of the network. The first media renderer is in communication with the second media renderer over the network.

### FIELD OF THE INVENTION

The present invention relates to networks in which media content information that is in the process of being rendered by one networked rendering device is movable for rendering by a second networked rendering device.

### BACKGROUND OF THE INVENTION

With the increasing use of digital devices for storing media content, a home or business environment will often have a number of different storage devices that a user would like to access, together with a number of different devices that can be used to view, listen to or otherwise render stored media content. For example, homes now include digital equipment that enable residents to watch television and surf the Internet at the same time on the same digital device, to view digital photographs and video on the television or on the computer, to network personal computers, set top terminals and other devices within the home to enable the sharing of documents, images, video, audio and other types of media. It is desirable to network these together so that a user can, for example, record a program on a digital video recorder (DVR) in one room and concurrently or subsequently view it on a television connected to a set top terminal in another room.

When watching a video program, slide show presentation or the like, or when playing a video game, the user may wish to move the viewing session from one location in the home to another. This can be a particularly useful feature when combined with common DVR functions such as pause and play. For example, a user may wish to pause a program such as a movie in the living room and then resume watching it in the kitchen. Similarly, a user may wish to start recording a program on a DVR in the family room and then move it so that it can be viewed through another set top terminal.

Currently, moving a viewing session for a program from one room to another can be a cumbersome process if it is possible at all. Typically, even when possible, vendor-proprietary implementations are generally employed. For instance, a set top terminal may provide the user with a menu function to move a program currently being played by the set top terminal. However, to perform this function the user generally needs to select from the menu the destination device to which the user wants to move the program. In order to select the appropriate destination device, the various networked devices must be given user-friendly names so that they can be readily identified. In addition to being able to identify the destination device, the user must also ensure that the destination device is not already in use so as to prevent a conflict from arising.

In addition, because these implementations are vendor specific, they use vendor-proprietary equipment from different manufacturers that cannot interoperate. For instance, a program currently being viewed with a DVR set-top manufactured by one vendor can not be moved to a set-top manufactured by a different vendor.

Accordingly, it would be desirable to simplify the process by which a user moves a viewing session from one networked device to another, even when those devices are manufactured by different vendors.

### BRIEF DESCRIPTION OF THE DRAWINGS

FIG. 1 shows one example of a home entertainment network 150 for use with an embodiment.

FIG. 2 shows a network of devices, for use with an embodiment, that employ a standard networking protocol such as Universal Plug and Play (UPnP).

FIG. 3 is a flowchart showing exemplary viewer interactions in an embodiment.

FIG. 4 is a signaling diagram of an embodiment showing one example of the interactions between two networked UPnP terminals when a viewer moves a program that is being viewed on one terminal (first terminal 1) to another terminal (second terminal 2).

FIG. 5 is a signaling diagram showing another exemplary embodiment of the interactions between two networked UPnP terminals when a viewer moves a program that is being viewed on one terminal (first terminal 1) to another terminal (second terminal 2).

### DETAILED DESCRIPTION

As detailed below, the aforementioned problems and limitations that arise when a user (i.e., a viewer) moves a viewing session from one location to another can be overcome by appropriately configuring a networked device such as a set top terminal so that it presents the user with a list of programs or other content items that are being rendered by other networked devices in the residence. When the user selects one of the content items, the networked device from which the selection is made can retrieve and render the selected content item.

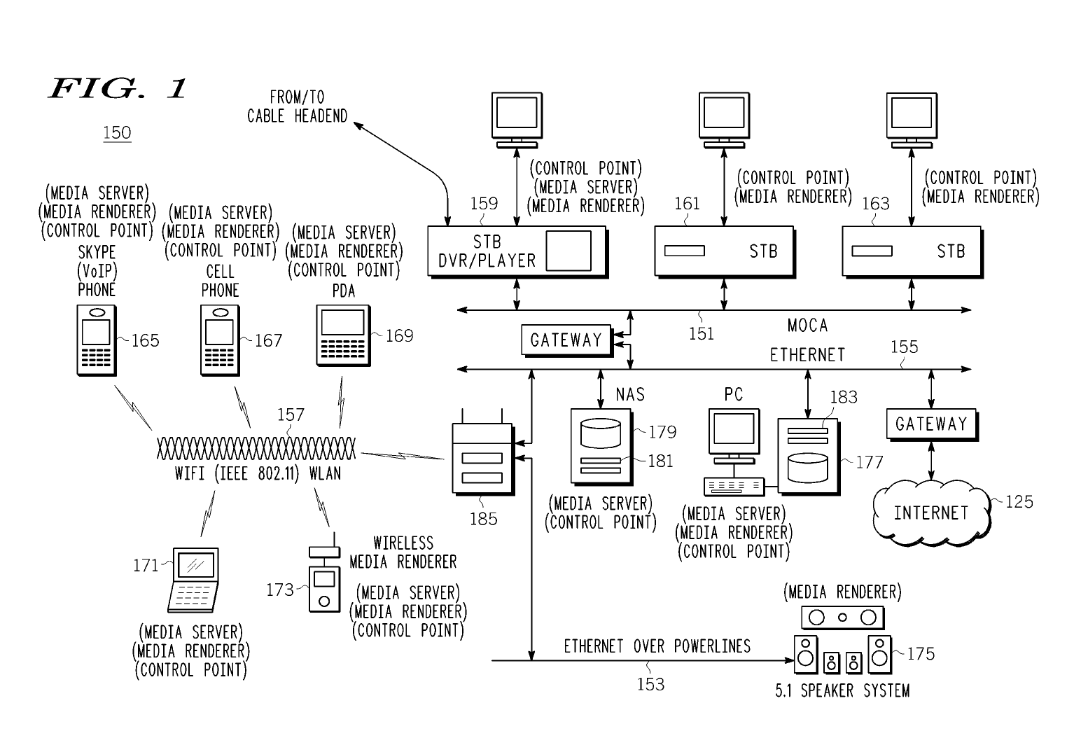

FIG. 1 shows one illustrative example of a home entertainment network 150 for use with an embodiment of the invention; however, many other configurations of network 150 are possible, and embodiments are not limited to the particular illustrated architecture or components, and need not include every one of the illustrated components shown in FIG. 1. It will be appreciated that the network 150 can be located at a home, a business facility, or other types of buildings or locations, and may in some embodiments include locations at more than one home, facility, or building. Coupled to the network 150 are various storage, retrieval, input, and/or playback devices that are typically located in different rooms of the house. The network 150 in this example is a network of networks and includes a Media over Coax (MOCA) network 151, an Ethernet over powerlines network 153, a wired local area network, e.g., an Ethernet 155, and a wireless network (wireless local area network, WLAN) 157, e.g., a Wi-Fi network that conforms to the IEEE 802.11 standard. The network 150 also includes a connection to another network, e.g., the Internet 125.

One device that communicates over network 150 is a DVR-equipped set top terminal 159 that is coupled via cable to a cable headend, and also coupled to the MOCA network 151. The set top terminal 159 is capable of playback and is also the source of AV content. Also coupled to the MOCA network are set top terminals 161 and 163, neither of which include a DVR The set top terminals 159, 161 and 163 can receive content over a broadband communications network such as a cable network, which is typically an all-coaxial or a hybrid-fiber/coax (HFC) cable network, a satellite network, or a xDSL (e.g., ADSL, ADLS2, ADSL2+, VDSL, and VDSL2) network.

Coupled to Ethernet 155 is a network attached storage device (NAS) 179 on which media content is stored and a personal computer (PC) 177. The Ethernet 155 is also coupled to the Internet 125 and to the Ethernet over powerlines network 153. A speaker system 175 is coupled to that Ethernet over powerlines network 153.

Several devices are shown coupled to the wireless network 157. A laptop PC 171 and a wireless portable media player 173, e.g., a wireless MP3 and video player 173, are operable to be coupled to the WLAN. Also connectable to the wireless network 157 are portable devices such as a voice-over-IP (VoIP) phone 165 and a mobile cellular phone 167 that includes a wireless network interface to connect to the wireless network 157. In some cases the phones 165 and 167 may also include components that are operable to store and play back content. A personal digital assistant (PDA) 169 is also coupled to wireless network 157. Wireless network 157 communicates with wired local area network 155 over wireless access point 185.

Home entertainment network 150 and the various devices networked thereto are of a type that offers seamless device discovery and control of data transfer between the networked devices independent of operations systems, programming languages, file formats and physical network connections. One example of a network architecture that offers these features is the UPnP open networking architecture. Of course, home entertainment network 150 may employ alternative network architectures, compliant with open or proprietary standards, which implement this functionality instead of (or in addition to) UPnP. For example, one such network architecture is the UCentric Media Protocol (UMP), which is an application suite available from Motorola. For purposes of illustration however, the following exposition will refer to the UPnP architecture.

UPnP is an example of a communications protocol which allows electronic devices produced by different manufacturers to operate together in this manner. UPnP is designed to support networking, with automatic discovery of new devices so that minimal or no configuration on the part of the user is necessary. This means a device can dynamically join a network, obtain an IP address, convey its capabilities, and learn about the presence and capabilities of other devices. A further development of UPnP is the UPnP Audio-Visual (AV) Architecture which describes extensions of the UPnP architecture relevant to Audio-Visual devices. The architecture is independent of any particular device type, content format, and transfer protocol, and supports a variety of devices such as televisions (TVs), videocassette recorders (VCRs), compact disc (CD) or digital versatile disc (DVD) players and jukeboxes, set-top boxes, stereos systems, MP3 players, still-image cameras, camcorders, electronic picture frames (EPFs), network storage devices, and personal computers. The UPnP AV Architecture allows devices to support different types of formats for the entertainment content (such as MPEG2, MPEG4, JPEG, MP3, Windows Media Architecture (WMA), bitmaps (BMP), NTSC, PAL, ATSC, etc.) and multiple types of transfer protocols (such as IEC-61883/IEEE-1394, HTTP GET/PUT/POST, RTP, TCP/IP sockets, UDP, etc.). Details concerning the UPnP AV Architecture can be obtained from “UPnP AV Architecture” published by the UPnP Forum.

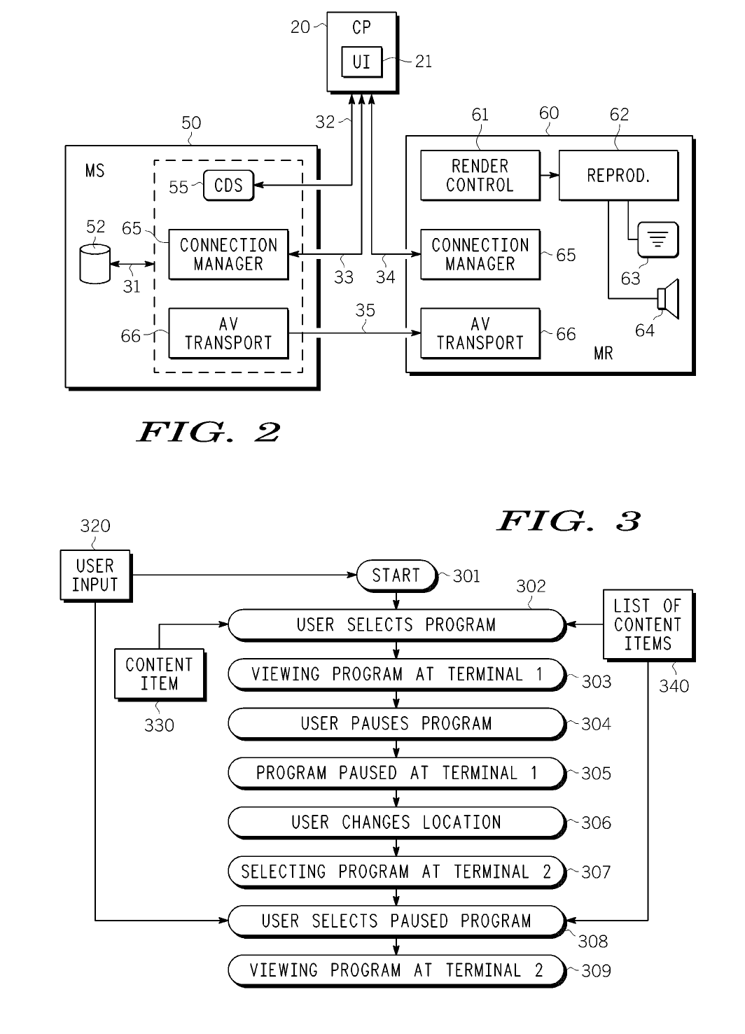

Referring to FIG. 2, the main components of an exemplary UPnP AV system suitable for use with an embodiment are a Control Point (CP) 20, a Media Server (MS) 50 and a Media Renderer (MR) 60. All of these are logical entities: a physical device may include only one of these entities (e.g. a Control Point 20 in the form of a remote control) or, more commonly, a combination of several of these entities. As an example, a CD or DVD player comprises a user interface and control circuitry for operating the player (a Control Point 20), apparatus for reading digital content from an optical disk (a Media Server 50) and apparatus for converting the digital content into an audio signal for presentation to a user (a Media Renderer 60). As another example, a set top terminal (e.g. set top terminals 161 and 163 in FIG. 1) is a Media Renderer 60 in the UPnP context whereas a set top terminal (e.g., set top terminal 159 in FIG. 1) that includes DVR functionality is both a Media Renderer 60 and a Media Server 50 in the UPnP context. Similarly, speaker system 175 is a Media Renderer 60 and PC 177 is capable of serving as a Media Server 50, a Media Renderer 60, and a Control Point 20. An exemplary role or roles of each of the networked devices in FIG. 1 is shown in parentheses.

It should be noted that references to the capitalized terms Control Point, Media Server and Media Renderer, for purposes of illustrating aspects of an exemplary embodiment, suggest logical entities that conform to the UPnP AV architecture. However, the use of lowercase terms such as control point, media server and media renderer refers more generally to logical entities that perform their respective functions of controlling a media player, serving media, and rendering media, without regard to whether they comply with the UPnP AV architecture or with any other open or proprietary architecture. The term “media player” means a device that includes a media renderer.

While in this disclosure, all three entities—the control point 20, media server 50 and media renderer 60—are often described as if they were independent devices on the network, and such a configuration is actually possible, e.g., a VCR (the media server 50), a control device, e.g., coupled to a remote control (the control point 20), and a TV (the media renderer 60), it will be understood that the UPnP AV architecture also supports arbitrary combinations of these entities within a single physical device. For example, a TV can be treated as a media player device, e.g., a display. However, since most TVs contain a built-in tuner, the TV can also act as a media server device because it could tune to a particular channel and send that content to a media renderer, e.g., its local display or some remote device such as a tuner-less display monitor. Similarly, many media servers and/or media players may also include control point functionality. For example, an MP3 renderer will likely have some UI controls (e.g. a small display and some buttons) that allow the user to control the playback of music.

In the exemplary embodiment depicted in FIG. 2, the UPnP AV Architecture defines a number of services that are hosted by both Media Servers and Media Renderers. In particular, the Content Directory Service (CDS) enumerates the available content (videos, music, pictures, and so forth). The Connection Manager determines how the content can be transferred from the Media Server to the Media Renderer devices. The AV Transport Service controls the flow of the content (play, stop, pause, seek, etc.). Each of these services is depicted by logical entities in FIG. 2. For instance, Media Server (MS) 50, which includes a storage medium 52 of media content, also supports a Content Directory Service (CDS) 55, which allows the CP in UPnP devices to access the content stored on MS devices, by among other things, cataloging the content in storage medium 52. The Media Server 50 also includes Connection Manager 65, which is used to manage connections between the Media Server 50 and other devices such as the Media Renderer 60. An AV Transport Service 66 allows control of the playback of content, with features such as stop, pause, seek, and the like. In an exemplary embodiment, any of the CDS 55, Connection Manager 65, and AV Transport Service 66 can access storage medium 52 via communication link 31.

Media Renderer (MR) 60 is responsible for rendering (reproducing) media content which is received from a Media Server 50. Reproduction equipment 62 is shown with a display 63 and speaker 64 although the output can take many forms. Typically, the reproduction equipment 62 includes one or more decoders, digital to analog converter and amplifiers. The Media Renderer 60 also supports a Connection Manager 65 for establishing a new connection with a Media Server and Render Control 61 for controlling the way in which the content is rendered. For audio reproduction this can include features such as a volume control. In an exemplary embodiment, MR 60 also includes a second AV Transport Service 66 that allows control of the playback of content, with features such as stop, pause, seek, and the like, and that can communicate with the first AV Transport Service 66 (in Media Server 50) via communication link 35.

Control Point (CP) 20 coordinates operation of the Media Server 50 and Media Renderer 60 and includes a user interface (UT) 21 by which a user can select content. The Control Point 20 supports the conventional UPnP mechanisms for discovering new devices and also supports mechanisms for finding the capabilities of Media Rendering devices and establishing connections between a Media Server and a Media Renderer. In an exemplary embodiment, the CP 20 can communicate with CDS 55 via a communication link 32, with Connection Manager 65 via communication link 33, and with Connection Manager 65 via communication link 34.

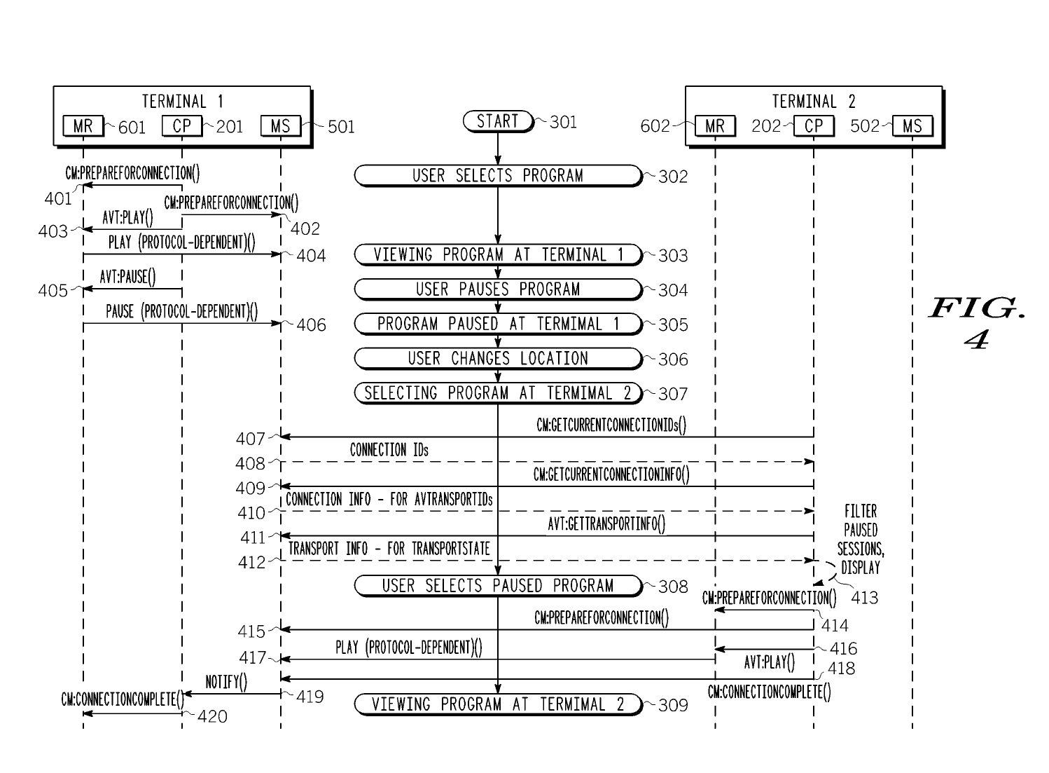

FIG. 3 is a flowchart showing exemplary viewer interactions in an embodiment. An illustrative method for interaction with a viewer begins at step 301 with receipt of a user input 320. At step 302, a user (e.g., a viewer) selects a content item 330 such as a program from a list of content items 340. At step 303, the user begins to view the content at a first terminal, designated in the flowchart as “Terminal 1.” At step 304, the user elects to pause the content. At step 305, the content item 330 is paused at the first terminal. At step 306, the user changes location, e.g., by traveling to the location of a second terminal, here designated in the flowchart as “Terminal 2.” At step 307, the user is presented an opportunity to select content at the second terminal, such as by using a user interface that presents choices to the user. At step 308, the user selects, from the list of content items 340, the program that was previously paused at the first terminal in step 305. At step 309, the user views the selected program at the second terminal.

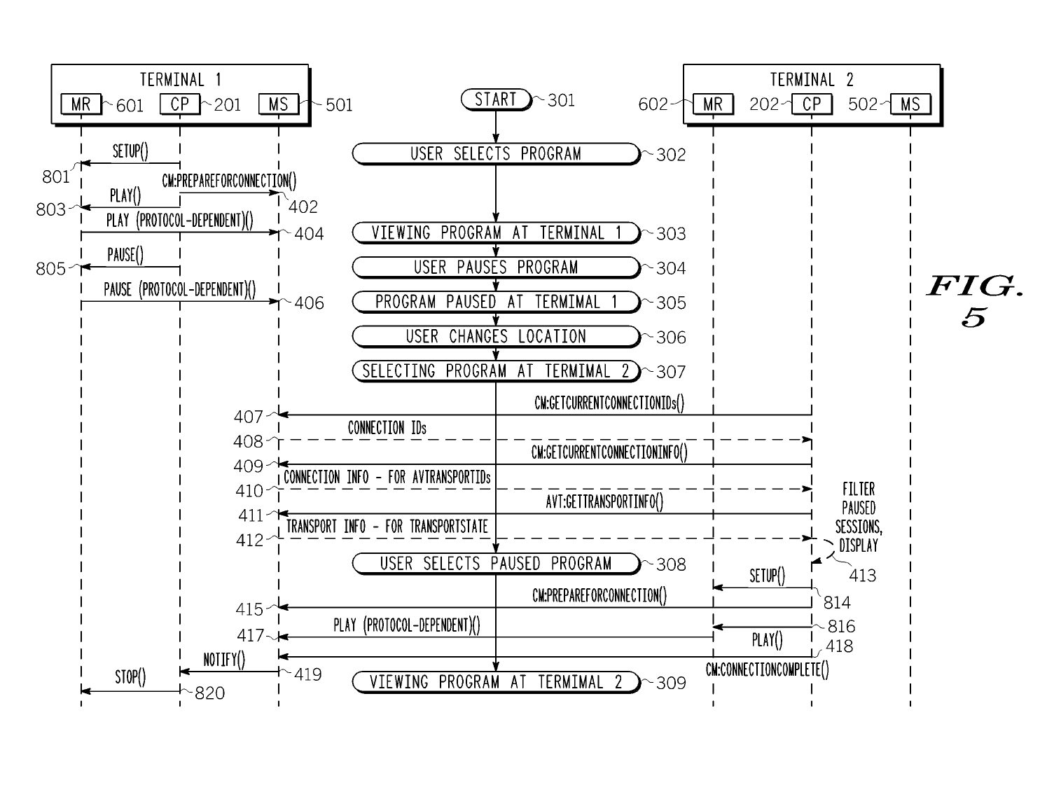

FIG. 4 is a signaling diagram of an exemplary embodiment showing the interactions between two networked UPnP terminals 1, 2, when a viewer moves a program that is being viewed on a first terminal 1 to a second terminal 2. In general, terminals 1 and 2 may correspond to any of the networked devices shown in FIG. 1. For generality of illustration only and not as a limitation on the techniques presented herein, in this example the media renderer, control point and media server in each terminal are assumed to be separate devices. The flow diagram of FIG. 3 is superimposed on the signaling diagram of FIG. 4, illustrating the sequence of events performed by a user as he or she moves the program from first terminal 1 to second terminal 2.

For greater clarity, in order to distinguish the media renderer 60, control point 20, and media server 50 of the first terminal 1 from the media renderer 60, control point 20, and media server 50 of the second terminal 2, distinct reference numerals are used. The exemplary first terminal 1 includes Media Renderer 601, Control Point 201, and Media Server 501. The exemplary second terminal 2 includes Media Renderer 602, Control Point 202, and Media Server 502.

At step 302, when a user first selects a content item 330 such as a program on the first terminal 1 from the list of content items 340, the CP 201 in the first terminal 1, at 401 and 402, establishes the connections to the Media Renderer 601 and the Media Server 501, e.g., by invoking CM:PrepareForConnection( ) actions using the Connection Manager 65 (shown in FIG. 2). Next, at 403, the CP 201 in first terminal 1 invokes Play( ), which is an action defined in the AV Transport Service of Media Renderer 601 which requests reproduction of an item available to the Media Server 501. In response, at 404, the Media Renderer 601 requests the Media Server 501 to transmit the requested content to the Media Renderer 601. The Media Server 501 transmits a stream of the requested content to the Media Renderer 601 so that the Media Renderer can reproduce the requested content. At step 303, the user is then able to view the requested content at the first terminal 1.

At a subsequent point in time, represented by step 304, the user pauses the program on terminal 1 in preparation for moving the program to another location. In response to the user command, the Control Point at 405 invokes Pause( ), which is also an action defined in the AV Transport Service of Media Renderer 601. In response, at 406, the Media Renderer 601 requests the Media Server 501 to pause transmission of the content, which occurs at step 305. It should be noted that if the Media Server 501 is a tuner receiving a live program, pausing the program requires that first terminal 1 be capable of buffering the program for timeshifting purposes.

At step 306, the user then goes to second terminal 2, which is typically located in another room in the residence, and at step 307, via a user interface associated with Control Point 202, the user requests a list of paused programs, which is a subset of the list of content items 340. In response, at 407, the Control Point 202 in second terminal 2 requests a list of current connections using a GetCurrentConnectionIDs action defined in the Connection Manager. The Media Server 501 provides the connection IDs at 408. At 409, the Control Point 202 uses each connection ID to request additional connection information using the GetCurrentConnectionInfo action defined by the Connection Manager. The additional information, which notably includes the AVTransportID of each connection, is provided to the Control Point 202 by the Media Server 501 at 410. At 411 the Control Point 202 uses this information to acquire at 412 additional information concerning each transport using a GetTransportInfo action from the AVTransport service in Media Server 501. In particular, the Control Point 202 obtains the TransportState of each transport instance. At 413, the Control Point 202 filters this information to identify those transports that are paused and presents them to the user.

When the user, at step 308, selects the desired paused program, the Control Point 202, at 414 and 415, establishes the connections to its own Media Renderer 602 and to the Media Server 501 in first terminal 1 using the Connection Manager. Next, at 416, the CP 202 invokes Play( ), to the AV Transport Service of Media Renderer 602 which requests reproduction of the desired paused program. In response, at 417, the Media Renderer 602 in first terminal 1 requests the Media Server 501 in first terminal 1 to transmit the requested content to the Media Renderer 602. The Media Server 501 transmits a stream of the requested content to the Media Renderer 602 so that the Media Renderer can reproduce the requested content, thereby allowing the user to view the requested program using second terminal 2, at step 309.

When the user selects the paused program on second terminal 2 the Control Point 202 in second terminal 2 plays the program as described above and also stops the playback on first terminal 1. The Control Point 202 stops the playback, at 418, using a ConnectionComplete call to the Media Server 501 defined in the Connection Manager. The Media Server 501, at 419, in turn notifies the Control Point 201 in first terminal 1. Control Point 201, at 420, then sends a ConnectionComplete call to the Media Renderer 601.

As the user continues to view the program using second terminal 2, the Control Point 202 can continue to interact with the Media Server 501 in first terminal 1, which can relay status information to the Control Point 201 in first terminal 1 using the UPnP General Event Notification Architecture (GENA) protocol.

FIG. 5 depicts a signaling diagram similar to that of FIG. 4, for an embodiment in which the functionality of both the media renderer 60 and the control point 20 reside in a single device. In UPnP implementations, such an embodiment may be referred to as a two-box model, rather than the three-box model shown in FIG. 4.

As previously noted, the sequence in FIG. 4 described above applies to the general case in which the media renderer 60, control point 20 and media server 50 are all separate devices. However, in many embodiments, of course, the functionality of two or even all three of these devices can be incorporated in a single device. For instance, a set top terminal typically includes the functionality of both the media renderer 60 and the control point 20. In such a case, as illustrated in FIG. 5, the control point 20 and media renderer 60 can interact using implementation-dependent operations instead of using the connection manager and the AV Transport Service 66 in the media renderer 60.

In most respects the operations depicted in the embodiment shown in FIG. 5 correspond to those depicted in FIG. 4. However, in the exemplary embodiment of FIG. 5, the exemplary first terminal 1 includes media renderer or player 601 in place of the UPnP compliant Media Renderer 601 shown in FIG. 4, and the exemplary second terminal 2 includes media renderer or player 602 in place of the UPnP compliant Media Renderer 602 shown in FIG. 4. Media player 601 receives instructions which need not be compliant with a UPnP implementation, such as a setup instruction at 801 in place of the CM:PrepareForConnection( ) instruction at 401 (shown in FIG. 4), a play instruction at 803 in place of the AVT:Play( ) instruction at 403 (shown in FIG. 4), pause instruction at 805 in place of the AVT:Pause( ) instruction at 405 (shown in FIG. 4), and a stop instruction at 820 in place of the CM:ConnectionComplete( ) instruction at 420 (shown in FIG. 4). Similarly, media player 602 receives a setup instruction at 814 in place of the CM:PrepareForConnection( ) action at 414 (shown in FIG. 4), and a play instruction at 816 in place of the AVT:Play( ) action at 416 (shown in FIG. 4).

The signaling diagrams presented in FIGS. 4 and 5 assume that the user is moving a viewing session from one location to another. The user may accomplish this by pausing the program being rendered by the original media renderer 601. In other cases however, the user may allow the viewing session to continue to be rendered by the original media renderer 601 while it is also being rendered by the destination media renderer 602. In this case the filtering performed by the control point 20 so as to only present paused programs can be eliminated.

Those of ordinary skill in the art will recognize that in some cases the transfer of a viewing session from one location to another in the manner described above may necessitate the use of additional systems and protocols to ensure compliance with such things as Quality of Service (QoS) needs and Digital Rights Management (DRM) requirements. For example, it may be necessary to ensure that the destination media renderer is authorized to render the content item that is being moved. As another example, the destination media renderer may need to determine if the connection over which the transferred content is being received has sufficient bandwidth to adequately perform the transfer. For instance, if a user attempts to transfer a high definition video program to a media renderer 60 of the cell phone 167 in FIG. 1, the cell phone 167 may need to recognize and inform the user that the connection is not sufficient to support transfer of the requested content item.

1. A method of rendering digital content items with a second media renderer in a network having at least one control point, at least one media server, and a plurality of media renderers, the method comprising:
presenting a list of one or more digital content items currently being rendered by any media renderer in communication with the network;
receiving a user input selecting a digital content item that is currently being rendered by a first media renderer; and
in response to the user input, causing the second media renderer to request transmission of the selected digital content item from a first media server associated with the first media renderer to the second media renderer;
wherein the network is configured to allow digital content items stored in any media server in communication with the network to be located by any control point of the network and to be transferred for rendering by any media renderer of the network; and
wherein the first media renderer is in communication with the second media renderer over the network.

2. The method of claim 1 further comprising receiving a user input selecting a function to move content to the second media renderer.

3. The method of claim 2 wherein the function to move content that is selected is a function to move content that is currently being paused by the first media renderer and wherein the list of content items that is presented is a list of paused content items.

4. The method of claim 1 wherein the network is a universal plug and play (UPnP) network and the first and second media renderers and the first media server are UPnP compliant devices.

5. The method of claim 1 wherein at least one of the first and second media renderers is incorporated in a set top terminal.

6. The method of claim 5 wherein the other one of the first and second media renderers is a personal computer.

7. The method of claim 1 further comprising causing the first media renderer to terminate rendering the selected content item.

8. The method of claim 1 wherein the first media server comprises a digital video recorder.

9. The method of claim 1 wherein the first media server comprises a television tuner.

10. The method of claim 9 further comprising recording the selected content onto a digital video recorder while it is being rendered by the second media renderer.

11. The method of claim 1 wherein the presenting, receiving and causing steps are performed by a control point associated with the first media renderer and with the first media server.

12. The method of claim 1 further comprising presenting a current rendering state of each of the one or more digital content items in the list.

13. The method of claim 12 wherein the current rendering state is selected from the group consisting of play and pause.

14. The method of claim 12 wherein the list identifies previously transferred digital content items that are being rendered by a media renderer not associated with a media server supplying the previously transferred digital content items.

15. A computer-readable medium containing instructions which, when performed by one or more processors disposed in an electronic device, implement a user interface, the instructions comprising:
displaying in the user interface a list of content items currently being rendered by at least one media renderer in communication with a network;
receiving in the user interface a user input responsively to the displaying to indicate a selected content item being rendered by a first of the media renderers; and
invoking a method for retrieving and rendering the selected content item on a second of the media renderers.

16. The computer-readable medium of claim 15 wherein the method for retrieving and rendering the selected content item comprises causing the second media renderer to request transmission of the selected content item from a first media server associated with the at least one media renderer to the second media renderer.

17. The computer-readable medium of claim 15 wherein the network is a universal plug and play (UPnP) network and the media renderers are UPnP compliant devices.

18. The computer-readable medium of claim 15 wherein at least one of the media renderers is incorporated in a set top terminal.

19. The computer-readable medium of claim 15 causing the at least one media renderer to terminate rendering the selected content item when rendering the selected content item with the second media renderer.

20. The computer-readable medium of claim 15 wherein the displaying and receiving steps are performed by a control point associated with the at least one media renderer.
